(19) United States
(12) Patent Application Publication
(10) Pub. No.: US 2011/0213674 A2
(43) Pub. Date: Sep. 1, 2011

(54) Online Marketplace for Sale of Discounted Stated Value Vouchers Redeemable by Vendors

(75) Inventors: Shlomo Shpun, Irvine, CA (US); Yaakov Shpun, Moshav Tzipori (IL); Michael Dershem, Voorhees, NJ (US)

(73) Assignee: Y.S. Shpun LLC, Irvine, CA (US)

(21) Appl. No.: 12/369,823

(22) Filed: Feb. 12, 2009

Related U.S. Application Data
(60) Provisional application No. 61/027,956, filed on Feb. 12, 2009.

(51) Int. Cl. G06Q 30/00

(52) U.S. Cl. 705/26.4

(57) ABSTRACT

A marketplace server computer for sale of stated value vouchers via an online marketplace. The vouchers are presented in a particular manner allowing for effective inventory management using rule-based approval of sales. The method involves receiving a vendor's commitment to sell vouchers, and maintaining a website for displaying a for-sale listing identifying the vouchers. Sales of vouchers are approved in accordance with predetermined rules, which rules may be changed by the vendor over time, and during a single for-sale listing of a single lot of vouchers. The for-sale listing may identify a maximum number of vouchers for sale, although more than the maximum number may be sold. Each buyer is thus encouraged to provide a buyer-specific highest acceptable bid for a voucher, and the vendor thus provides a buyer-specific discount that is the minimum acceptable discount for each particular buyer, provide that such bid is acceptable to the vendor.

### CROSS-REFERENCE TO RELATED APPLICATION

This application claims the benefit of priority under 35 U.S.C. §119(e) of U.S. Provisional Patent Application No. 61/027,956, filed Feb. 12, 2008, the entire disclosure of which is hereby incorporated herein by reference.

### FIELD OF THE INVENTION

The present invention relates generally to a method and system implementing an online marketplace for the sale of stated value vouchers at a discount from face value, in accordance with rules established by vendors for sale of stated value vouchers that the vendor will redeem. More particularly, the present invention relates to a method and system permitting sale of merchandise at prices that are discounted to a buyer-specific extent, thus allowing for optimization of revenues and profits.

### DISCUSSION OF RELATED ART

In the context of retail sale of goods and services, “sales” in which such goods and services, or selected subsets of goods and services, are offered for sale by a vendor at a discount. For example, a particular sale event may allow for purchase of electronics items from a specified vendor at 25% less than the usual retail price. When executed properly, sale events may be effective in increasing inventory turnover, liquidation obsolete or near-obsolete merchandise, increasing revenues and increasing profits.

It will be appreciated, however, that it may be difficult to properly execute a sale event, in that it is often difficult to determine in advance a sufficient discount that will provide the desired effect. Further, particularly when the group of potential purchasers is diverse, any particular discount may provide an inadequate incentive for certain purchasers, and an excessive incentive for other purchasers, which results in lost profits. Further still, many conventional sales are manufacturer-sponsored, and thus do not apply to all of a single retailer's merchandise, or otherwise have limitations or exclusions of selected merchandise.

Further, many vendors wish to present an exclusive, prestigious image that may be inconsistent with a public announcement of a sale event.

What is needed is a method and system that provides the inventory-management advantages of sale events, and avoids the sometimes undesirable public announcements of sales, while allowing for optimization of revenues and/or profits.

### BRIEF DESCRIPTION OF THE FIGURES

FIG. 1 is a is a diagram of an exemplary environment for operation of a marketplace server system in accordance with the present invention;

FIG. 2 is a flow diagram of an exemplary overview of a method for discounted sale of stated value vouchers in accordance with the present invention;

FIG. 3 is an image of an exemplary graphical user interface window identifying vouchers available for sale in accordance with the present invention;

FIG. 4 is an image of an exemplary graphical user interface window displaying a for-sale listing for an exemplary voucher, in accordance with the present invention;

FIG. 5 is a flow diagram of an exemplary method for approval of sales of stated value vouchers in accordance with the present invention;

FIG. 6 is a flow diagram of an exemplary method for managing payments for sales of stated value vouchers in accordance with the present invention; and

FIG. 7 is a block diagram of a system for carrying out the methods of the present invention.

### SUMMARY

The present invention relates generally to computer-implemented methods involving sale of vouchers, such as gift cards or gift certificates, via an online marketplace. Such vouchers have a stated cash value, and vouchers are sold at a discount from the stated cash value. In accordance with the present invention, the vouchers are presented for sale and sold in a particular manner that allows for effective management of a vendor's inventory of items for sale, e.g. by providing each buyer with a buyer-specific discount for purchase of items (goods or services) from a vendor. By varying rules, unknown to the buyers, for approving completion of sales transactions for stated value vouchers, the vendor can moderate sales of items between a lower-discount, premium-priced, inventory retention strategy (e.g., by temporarily approving sale of $100 stated value vouchers at $99 and above) and a higher-discount, sale-priced, inventory liquidation strategy (e.g., by temporarily approving sale of $100 stated value vouchers at $60 and above). Further, such moderation can be achieved in a manner that is not readily apparent to consumers, in that an individual consumer does not perceive that the vendor has placed its items “on sale” to the public, but rather perceives merely that the individual consumer has an opportunity to obtain a bargain for purchasing a full-price item at a lower price (e.g., using a $100 stated value voucher to purchase an tem priced at $100, when the individual consumer has purchased the $100 stated value voucher at a discount, e.g. for only $60).

In one embodiment, the method involves receiving at the marketplace server computer the vendor's commitment to sell stated value vouchers having a stated cash value, and operating a marketplace server computer to maintain a website for displaying at a bidder's computing device a for-sale listing identifying a stated value voucher available for sale but omitting information identifying any pending bids, and for accepting the bidder's bid for at least one stated value voucher. The method further involves referencing a predetermined rule for accepting a bid for sale of a stated value voucher, approving sale of a respective stated value voucher to a corresponding bidder for each bid acceptable according to the rule, and tendering the respective stated value voucher to each corresponding bidder for each approved sale.

In another embodiment, the method involves receiving the vendor's identification of a minimum bid acceptable to the vendor for sale of a stated value voucher, the vendor providing varying instructions from time to time, and further involves receiving bids for the stated value vouchers, comparing each of the plurality of bids to the vendor's current time-variant minimum acceptable bid, and approving sale of a stated value voucher for each bid exceeding a current minimum acceptable bid, and tendering a respective stated value voucher to each respective bidder for each approved sale. The method further comprises transmitting data for causing display at a bidder's computing device of a for-sale listing identifying a specified number of the stated value vouchers available for sale, the for-sale listing omitting information identifying any pending bids, and for accepting the bidder's bid for at least one of the stated value vouchers, where a collective number of approved sales exceeds the specified number of stated value vouchers for sale.

### DETAILED DESCRIPTION

The present invention provides a method and system implementing an online marketplace for the sale of stated value vouchers at a discount from the stated value. The online marketplace may be provided in the form of an internet or intranet-type website configured to accept for-sale listings of stated value vouchers from vendors, and to receive bids and payment information from bidders, who may become buyers. By way of example, the website may be accessible via personal computers, PDAs, smartphones or other mobile devices, or via network-connected kiosks placed in retail stores, shopping malls, or the like. Sales of the vouchers via the online marketplace are conducted in accordance with rules established by each vendor for sale of stated value vouchers it will redeem. Accordingly, the present invention relates to a method and system permitting sale of merchandise at prices that are discounted to a buyer-specific extent, thus allowing for optimization of revenues and profits. Thus, the inventive method and system provides the inventory-management advantages of sale events, and avoids the sometimes undesirable public announcements of sales, while allowing for optimization of revenues and/or profits.

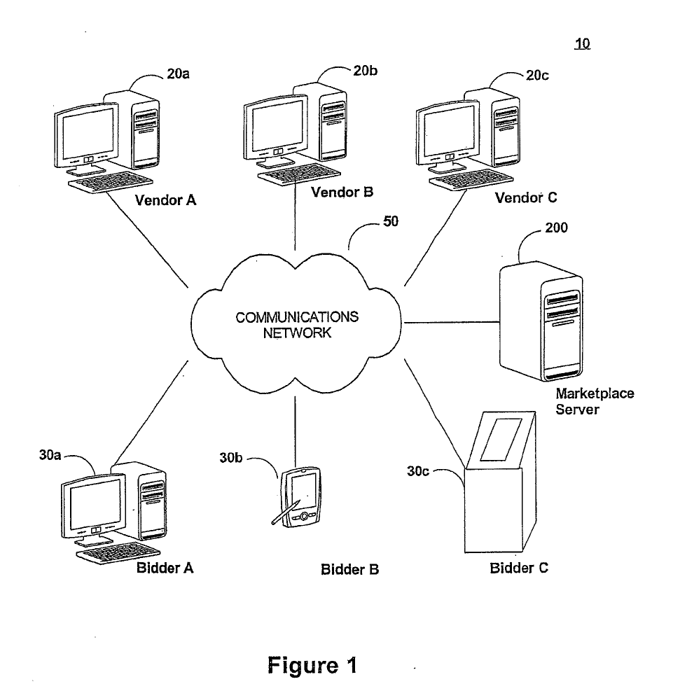

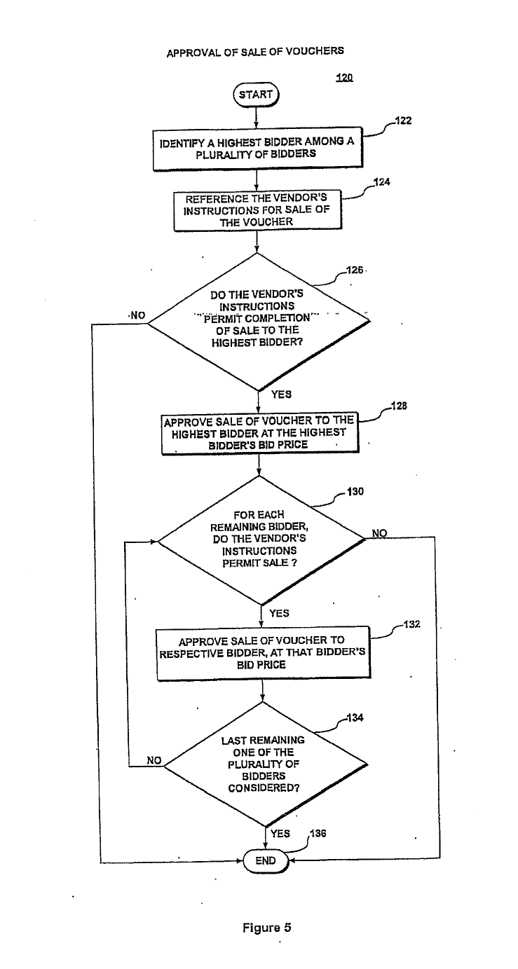

The present invention may be understood with reference to the exemplary, simplified network environment 10 of FIG. 1. As shown in FIG. 1, the exemplary networked environment 10 includes a marketplace server 200 that includes conventional computing hardware but is specially-configured with special-purpose software in accordance with the present invention to provide a special-purpose machine capable of carrying out the inventive methods described herein, as discussed in further detail with reference to FIG. 5. The network environment 10 further includes a plurality of vendor systems 20a, 20b, 20ct and a plurality of bidder systems 30a, 30b, 30c that may communicate with the marketplace server 200 by a communications network 50, such as the Internet. The marketplace server is configured to present a website interface via which vendors and bidders may interact with an online marketplace for the discounted sale of stated value vouchers. Stated value vouchers are well known in the art, in various forms. Generally, a stated value voucher is a voucher having a stated cash value, e.g. $50, $100, etc., that is redeemable by a vendor, in connection with a sale by the vendor, in a same-as-cash manner up to the amount stated. Examples of stated value vouchers include printed gift certificates, conventional plastic gift cards, coupon codes in electronic or printed form, and the like. A Macy's $100 gift card is an example of a stated value voucher.

Accordingly, each bidder system 30a, 30b, 30c may include conventional computerized hardware and software for browsing the web, such as a suitably configured personal computer, a PDA, smart-phone, or the like. Each vendor system, 20a, 20b, 20c, includes conventional computerized hardware and software for browsing the web, and for performing payment processing and other operations generally known in the art, or described herein.

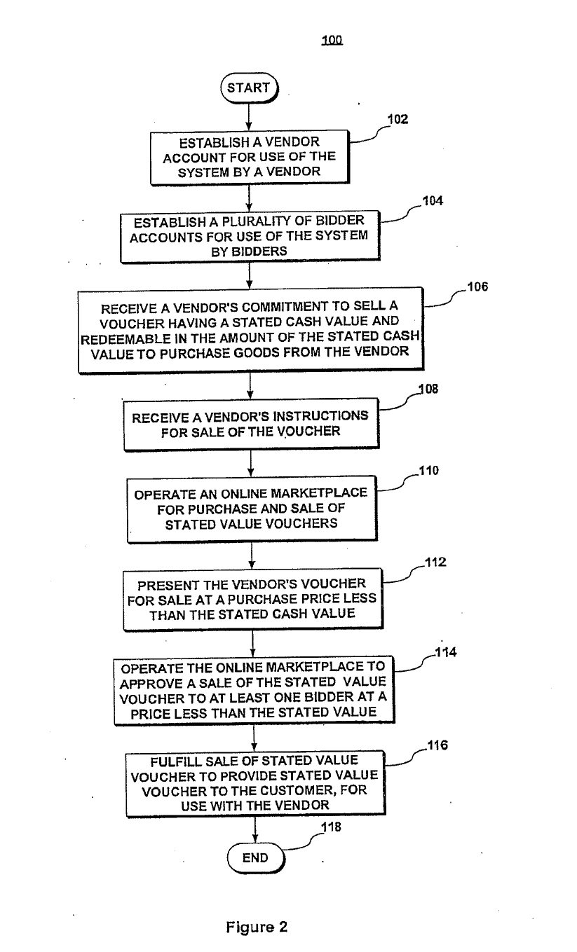

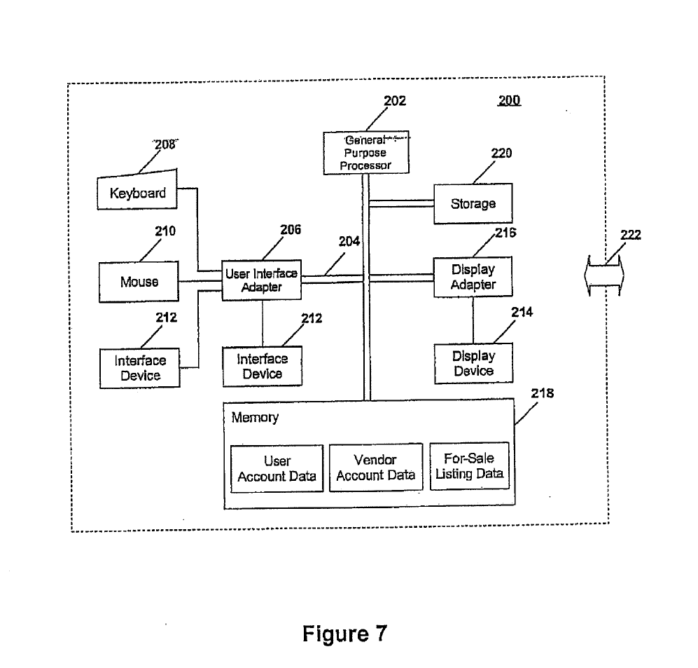

FIG. 2 is a flow diagram 100 of an exemplary overview of a method for the discounted purchase and sale of stated value vouchers in accordance with the present invention. Referring now to FIG. 2, the exemplary method begins with establishing a vendor account for use of the marketplace system (implemented by the marketplace server 200) described herein, as shown in step 102. For example, this may involve an individual's operation of a vendor system 20a to log on to the marketplace system via a website interface presented by the marketplace server 200. It should be noted that this type of configuration includes an intranet-type website, such as may be hosted by the vendor or a third party for only a single vendor, such as Macy's. A vendor account may be created, and associated information stored by the marketplace server 200, in a conventional manner. Typically, establishment of the vendor account will involve providing a record of the vendor's name, address, payment processing information, and any structures that the vendor may wish to provide retrospect to vouchers that it may subsequently list for sale via marketplace system. The payment processing information may include instructions for providing encrypted information to the vendor for processing of payments for purchase of vouchers. Data capturing such information and relating the vendor account may be stored for subsequent retrieval in a memory 218 of the system/marketplace server 200, as shown in FIG. 7.

Next, the method involves establishment of a plurality of bidder accounts for use of the system by bidders, as shown in step 104. For example, this may involve an individual's operation of a bidder system 30a, such as a personal computer (PC), a PDA, smartphone or other mobile device, or a kiosk, to log on to the marketplace system via the website interface presented by the marketplace server 200. It should be noted that the use of mobile device presents opportunities for GPS-based auctions, e.g. to solicit an individual to participate in an auction for vouchers for a retailer in physical proximity to the individual's present location as determined using GPS locating techniques. A bidder account may be created, and associated information stored by the marketplace server 200, in a conventional manner. Typically, establishment of the bidder account will involve providing a record of the bidder's name, mailing address, e-mail address, and payment processing information. Data capturing such information and relating the vendor account may be stored for subsequent retrieval in a memory 218 of the system/marketplace server 200, as shown in FIG. 7.

The system may then subsequently receive a vendor's commitment to sell a voucher having a stated cash value and redeemable in the amount of the stated cash value to purchase goods from the vendor, i.e., a stated value voucher, as shown at step 106. In other words, a vendor may login to his vendor account and identify a lot of vouchers for sale. For example, the vendor may do so by creating a for-sale listing identifying a lot of 250 Home Depot gift card vouchers, each having a stated value of $100.

Next, the method involves receiving a vendor's instructions for sale of the voucher, as shown at step 108 of FIG. 2. For example, this may include an agreement to sell the voucher in accordance with pre-determined rules or guidelines applicable within the system. Alternatively, this step may include a vendor-selected set of rules or guidelines that may be presented to the vendor in the form of alternative options. By way of further example, this step may include a vendor's identification of instructions as free-form text, or by the vendor's selection of individual options from a menu of options. In the context of a computerized system, a website-based interface may be provided by which a vendor can logon to a computerized system, e.g., via a personal computer (PC), a PDA, smartphone or other mobile computing device, or a kiosk, etc., in accordance with the present invention, using a predetermined username and password to access the vendor's account, and to provide such instructions. The instructions may provide parameters for sale of a particular voucher or set of vouchers. For example, the instructions may establish a number of vouchers that may be sold, and/or an initial or minimum bid price. For example, the vendor may provide instruction, textually, by selecting options from menus, etc., to cause the lot of vouchers to be placed up for blind auction for a five-day period beginning June 1, to permit sale of the voucher for any amount exceeding $85, and to permit sale of more than the identified number of available vouchers (more than 250, in this example). In selected embodiments, a third party operator of the system must approve the vendor's for-sale listing and/or instructions prior to its posting in the online marketplace. It should be appreciated that such approval may be granted after manual review by a human, or by the system in automated fashion according to rules established by the third party operator, and stored by the system.

The method further includes operation of online marketplace for purchase and sale of vouchers, as shown at step 110 of FIG. 2. The vendor's voucher is then presented for sale at a purchase price less than the stated cash value of the voucher, as shown at step 112. For example, this may involve adding entries to a database of stated value vouchers presently available for purchase. Further, this may involve display, via the website, of information presenting the voucher for sale, including display of the price at which the voucher may be purchased, at which a minimum bid will be accepted. In preferred embodiments, the information displayed does not include an identification of a sale price or a current highest bid price. Accordingly, the voucher may be presented for sale at a price that is not displayed, but that is less than the stated cash value, e.g. as specified by the vendor's instructions for sale of the voucher, and that is greater than a minimum bid, if any, established by the vendor. For example, information displayed via the website may indicate only that a bid will be accepted (without a stated minimum) for a specific voucher having an identified stated cash value, e.g. $100. The vendor (e.g., The Home Depot, Macy's, etc.) may be identified.

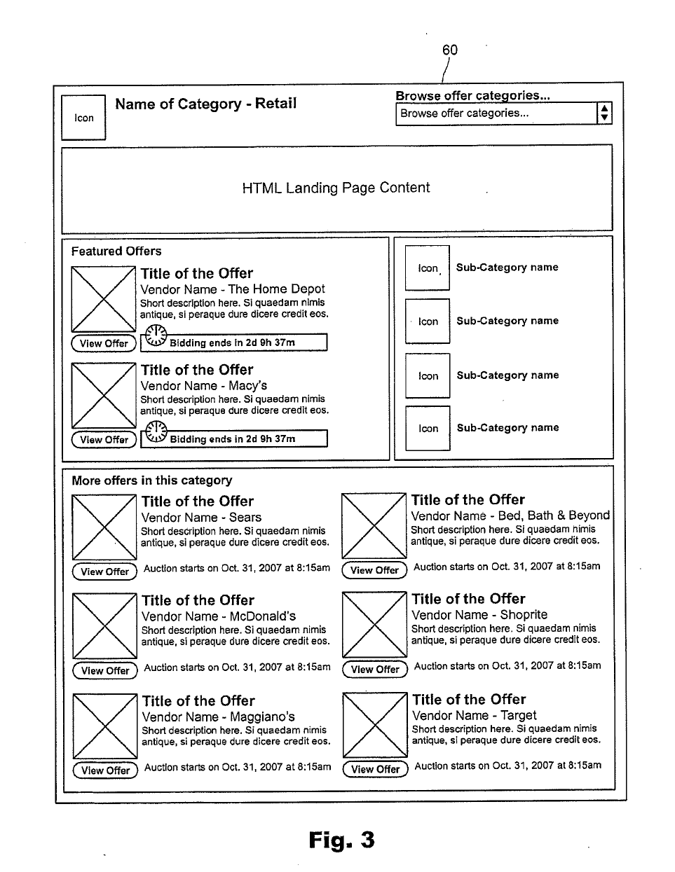

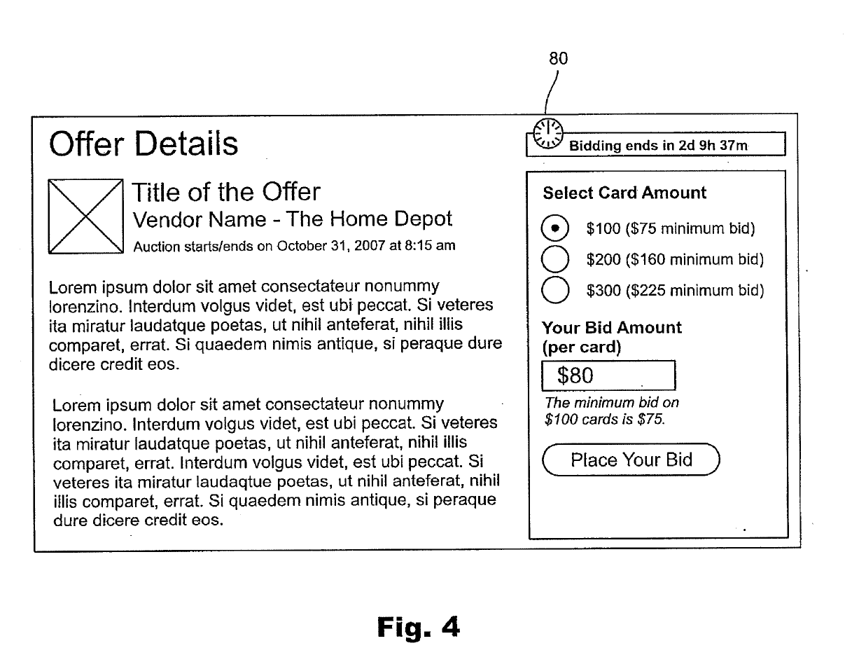

For example, the marketplace server may include web server functionality causing a website-based online marketplace to be maintained so that individual bidders may use their systems 30a, 30b, 30c to browse the website and search for stated value vouchers presently listed for sale. FIG. 3 is an image of an exemplary graphical user interface window 60 that may be displayed by the marketplace server 200 via a bidder system 30a, 30b, 30c, that identifies vouchers available for sale. FIG. 4 is an image of an exemplary graphical user interface window 80 displaying a for-sale listing for an exemplary Home Depot voucher, in accordance with the present invention. By presentation of the bid window 80, an operator of a bidder system 30a, 30b, 30c is permitted to enter a bid for the purchase of a stated value voucher. The website is also operable to permit the bidder to pay for any purchased vouchers, and perform any actions required for fulfillment of a purchased voucher, as discussed in greater detail below.

The online marketplace is then operated to selectively approve sales of the stated value voucher(s) to bidders at a price less than the stated value, as shown at step 114. By way of example, the online marketplace may be operated to conduct an auction for a voucher, to permit a simple purchase/sale transaction, etc. In a preferred embodiment, the system is operated to conduct a blind auction for the voucher(s), in which neither a current bid value, nor a highest paid value is displayed to a prospective bidders/purchaser in connection with presentation of the voucher for sale. See FIG. 4. The auction format leverages risk-taking behavior of shoppers, and allows each buying bidder to feel like a “winner.” Optionally, a quantity of vouchers available may be displayed. The quantity displayed may be more or less than the actual number of vouchers that the vendor is willing to sell.

In one embodiment, the auction is conducted as a Dutch auction. In such an auction, X available vouchers are sold to the X highest bidders at the close of the auction.

In a variation of a conventional blind Dutch auction that is in accordance with the present invention, a voucher is sold to every bidder, or every bidder meeting the vendor's criteria set forth in its instructions, at each respective bidder's bid price. In this manner, each bidder receives the same purchasing value of the stated value certificate (e.g., $100), but each bidder/buyer is enabled to purchase merchandise at a bidder/buyer-specific discount. In other words, a bidder offering $99 for a $100 voucher will receive $100 of purchasing power for purchasing goods at a 1% discount. Another buyer offering $90 for the $100 voucher receives $100 of purchasing power at a 10% discount. Another buyer offering $80 for the $100 voucher receives $100 of purchasing power at a 20% discount. Accordingly, each buyer receives a buyer-specific discount. In this manner, each buyer's discount is likely sufficient to incentivize that buyer to purchase and yet is unlikely to be more, or at least not significantly more, than a minimum discount that would be required to incentivize that buyer to purchase. Further, the 20% discount required for one buyer is not granted to another buyer for whom only a 1%, or 10%, discount would be sufficient to incentivize a purchase. In other words, rather than having the vendor make an independent determination as to a single discount that will work best with a group of buyers, each buyer is effectively permitted to state a discount that is sufficient, from the buyer's perspective, to incentivize a purchase—i.e., to set a buyer-specific discount level. Of course, the buyer is uncertain as to whether the stated discount (as specified by the buyer's bid) will be accepted or be sufficient as compared with other bids, which encourages the buyer to enter a bid toward the high end (minimum discount) of the buyer's acceptable price range for the voucher. Accordingly, under-discounting of merchandise (resulting in undesirably low sales volume) and over-discounting of merchandise (resulting in high sales volume with undesirably low profits) are avoided. Further, brand erosion is prevented, and any premium pricing structures may be preserved. Further, the system allows for rapid modification of the discounts provided by simply changing the instructions for approving sales of vouchers. These changes in instructions can be implemented almost instantaneously. Accordingly, for example, approvals may be initially granted for deeply discounted vouchers, and such approvals may be subsequently granted only for less discounted vouchers, e.g., throughout a single day, a single afternoon, etc.

The method further includes fulfillment of the sale of the stated value voucher, as shown at step 116 in FIG. 2. Fulfillment may be carried out in a variety of ways. Generally, in the fulfillment step, the voucher is tendered to the purchaser so that the purchaser may have the voucher redeemed by the vendor towards a purchase by the buyer from the vendor. In one embodiment, fulfillment is carried out electronically. For example, the system may fulfill purchase of the voucher by sending to the buyer, via e-mail or other electronic transmission, a coupon code in bar code, textual, or other form, a human-readable printable voucher, etc. Alternatively, the system may fulfill purchase of the voucher by sending, by USPS mail, courier, etc. a physical printed certificate, physical card with magnetic stripe, etc. Alternatively, the system may provide, e.g. via an email from the marketplace server or from a vendor system to the bidder system, an access code to be entered at a voucher-dispensing vending-machine-style kiosk, e.g. at a shopping mall or other central location, or via a mobile device, e.g. using a mobile wallet.

Exemplary operation of the online marketplace to approve sales of vouchers is shown in flow diagram 120 of FIG. 5. The exemplary operation illustrated in FIG. 5 is illustrative of an online (web-based) marketplace for buying and selling stated value vouchers in which sale of the vouchers is conducted by blind, Dutch auction, in accordance with one embodiment of the present invention. In this context, a vendor (e.g., The Home Depot) has operated its vendor system 20a to interact with the online marketplace and commit to offer for sale a plurality of vouchers, each having a respective stated value, e.g. $100. Further, a plurality of bidders operated their bidder systems 30a (e.g., personal computer), 30b (e.g., PDA smartphone or other mobile computing device), 30c (e.g., kiosk or free-standing in-store display) to interact with the online marketplace, found the for-sale listing for the $100 Home Depot vouchers (see FIG. 3), and have each submitted to the online marketplace a respective bid amount (via a bid window such as that shown in FIG. 4). As shown in FIG. 5, this exemplary embodiment begins with identification of a highest bidder from among the plurality of bidders, as shown in step 122. For example, consider that bidder A has placed a bid of $80, bidder B has placed a bid of $90, and bidder C has placed a bid of $95 for respective ones of the vouchers. Accordingly, in step 122, a computerized system in accordance with the present invention, e.g. conventional server hardware configured with special-purpose software in accordance with the present invention, would determine bidder C to be the highest bidder. In step 124, the system references the vendor's instructions for sale of the voucher. For example, the sale listing for the voucher may identify the vendor, and any instructions previously provided by the vendor for sale of its vouchers generally, or for specific vouchers, may be stored in a memory of the system. For example, the instructions may provide that no more than X vouchers may be sold, or that no voucher may be sold for less than Y, or that no more than Z % of the vouchers may be sold for less than Y, etc. Any suitable desired constraint may be imposed by the vendor, stored as instructions in the memory, and implemented by the system.

Next, it is determined by the system whether the vendor's instructions permit completion of sale to the highest bidder, as shown in step 126. For example, if the highest bidder has bid $95, and the instructions provide that the vouchers may not be sold for less than $90, then it would be determined in step 126 at the vendor's instructions do not permit completion of sale to the highest bidder (bidder C), and thus the portion of the method related to the sale of the vouchers would end without sale in the vouchers, as shown in steps 126 and 136.

If, however, it is determined by the system in step 126 that the vendor's instructions do permit completion of sale to the highest bidder (bidder C) (e.g., if the instructions provide that vouchers may be sought for any amount more than $75), then the portion of the method relating to completion of sale of the vouchers continues, and sale of the stated value voucher to the highest bidder is approved, as shown at steps 126 and 128.

In accordance with the present invention, the approval process continues for each remaining one of the plurality of bidders, as shown at step 130. For each of the remaining bidders (Bidder A and Bidder B in this example), it is determined whether the vendor's instructions permit completion of the sale to the respective bidder being considered. If the instructions permit completion of sale to the next respective bidder, the system approves sale of a voucher to the respective bidder at that respective bidder's bid price, as shown at step 132. This continues until all bidders have been considered, or until the instructions no longer permit sale of vouchers, e.g. due to a limit on the vouchers to be sold, sale price limit, etc., as shown at steps 130, 134 and 136.

It should be noted that, in accordance with one embodiment of the present invention, and in contrast to conventional methods, the method may continue such that the number of vouchers sold exceeds a number of available vouchers that was represented to the bidders. For example, the system may display in the for-sale listing that 50 vouchers are available; however the system may approve sale of 100 or more vouchers. This promotes aggressive/high bidding for a relatively small number of vouchers. However, in accordance with the present invention, many more than the represented number of vouchers, e.g. 100, 500, 5000, etc., may be sold to bidders. In one embodiment, a voucher is sold to every bidder, at each bidder's respective bid price, even when the number of vouchers to be sold exceeds the represented number of vouchers. In another embodiment, every bidder offering a bid consistent with the vendor's instructions is sold a voucher, even when the number of vouchers to be sold exceeds the represented number of vouchers.

The sale of more vouchers than represented is often acceptable to the vendor because the vendor can apply controls (in the form of instructions) to ensure that vouchers are sold such that only an acceptable discount will be provided. Further, the vouchers are sold in advance of redemption for merchandise, so the vendor may enjoy a “float” period during which it has use of the buyer's money paid for the voucher, as well-known in the gift-certificate industry.

The method is also advantageous in that it may be used to effectively provide “secret sales”, in that the voucher-holding buyer will receive a discount on purchased merchandise, as the result of purchase of the stated value voucher at less than the stated value, and yet other in-store or online shoppers may be unaware of any discounting of merchandise, and may thus be content to pay for merchandise without a discount. This allows for maintenance of an exclusive, never-on-sale image for premium brands, stores, etc.

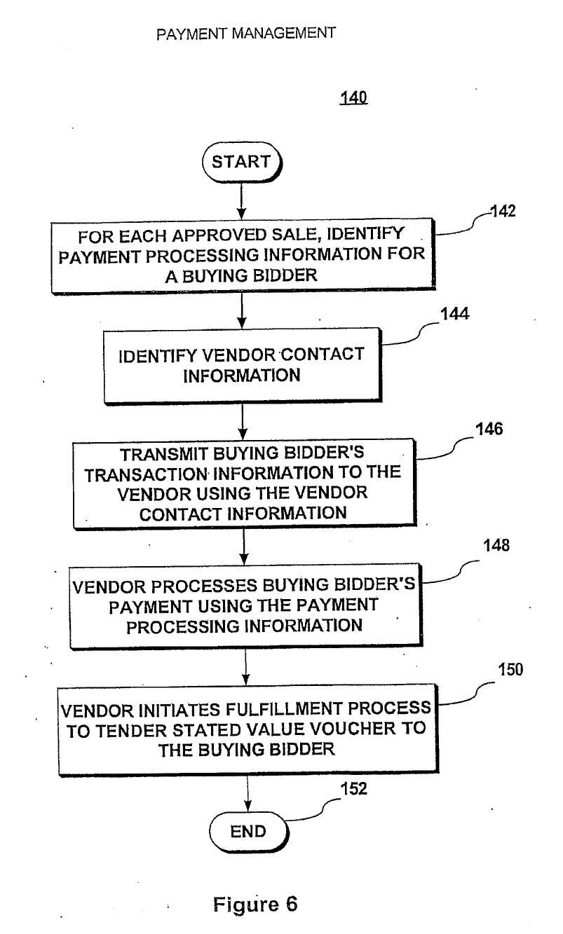

In accordance with another aspect of the present invention, a system for carrying out the inventive methods described herein is further configured to process payments for approved sales of vouchers. Accordingly, as shown in the flow diagram 140 of FIG. 6, for each approved sale, the system identifies payment processing information for a buying bidder, as shown at step 142. For example, this may involve receipt of credit card account number and charge information provided as typed input to a website interface of the system by the buying bidder after approval of a sale of the voucher to the bidder. In this manner, the system does not need to provide for long-term storage of credit card/payment information, and avoids the resulting risks relating to safeguarding such information. Alternatively, for example, this may involve retrieval from a memory 218, e.g. a database stored in a memory of the system, of credit card account number and charge information etc. that was previously provided by the bidder and stored by the system, in association with the user's account, as shown in FIG. 7.

The system then identifies vendor contact information, as shown in step 144. For example, this may involve reference to vendor contact information stored in the for-sale listing for the voucher, or reference to vendor contact information stored in the memory 218, e.g. a database, of the system, such as information that was previously provided by the vendor and stored by the system in association with the vendor's account, as shown in FIG. 7.

In accordance with a certain embodiment of the present invention, the system/server 200 does not process the payment. In other words, the system 200 does not communicate directly with a credit card or other payment clearance network as is typical for many online retailer websites or retail stores. Instead, the system transmits, via the Internet or other network, the buying bidder's transaction information to the vendor's system using the vendor contact information, as shown in step 146. For example, this may involve transmission to a secure electronic repository of information, using electronic data interchange (EDI), or other electronic transmission of information. After such information is deposited in the repository, it is retrievable only through a systematically-generated password initiated by and directed to the vendor. Preferably, the information is first encrypted by the server 200, before transmission to the vendor's system. As a practical matter, the server 200 may create a batch file of multiple buying bidders for one or more auctions/sales, and may aggregate transaction information for a single vendor, encrypt such batch file, and transmit the encrypted batch file to the vendor for decryption, payment processing, and fulfillment. The vendor's computerized systems are therefore configured for decryption, payment processing, and fulfillment, in accordance with the present invention. In the event of an inability to process a payment, the vendor may notify the marketplace server, and will not proceed to fulfillment for that buying bidder.

In alternative embodiments, the system/server 200 may process the payment, and either the vendor or the operator of the system may attend to fulfillment.

The transaction information includes the buying bidder's payment processing information, transaction-related information, such as quantity, sale price, stated value of voucher, etc. Additionally, the transaction information includes information required for fulfillment of the sale, i.e., tendering of the voucher to the buying bidder. Accordingly, the transaction information may include a mailing address of the buying bidder if the sale will be fulfilled by mailing a voucher, or may include the buying bidder's e-mail address if the buying bidder is going to be e-mailed a voucher, coupon code, or other information required for fulfillment. In certain embodiments, the system may provide the individual with e-mail alerts, text alerts, to voice alerts regarding auction listings or auction status. Optionally, a single system-specific “universal” card, similar to a gift card, may be issued to an individual that maintains voucher balances with numerous different vendors. In certain embodiments, the bidder may use an “auction concierge” service to provide automated instructions for entering bids, etc. according to predefined rules approved or established by the bidder.

In accordance with the present invention, the vendor then processes the buying bidder's payment using the payment processing information, as shown in step 148. For example, this may involve the vendor's system 20a, 20b, 20c direct communication with a credit card or other payment clearance network, as is well known in the art.

The vendor then initiates the fulfillment process to tender the stated value voucher to the buying bidder, as shown in step 150, and the method ends as shown at 152. In one embodiment, the fulfillment step involves notifying the system that the payment has been processed such that the system may proceed to fulfillment of the sale. In another embodiment, the vendor takes all steps necessary for fulfillment of the sale without further involvement of the system. As described above, fulfillment may involve mailing or shipping a physical voucher to a buying bidder, electronic transmission of a coupon code or other voucher information to the buying bidder via email, etc., or may involve electronic transmission of information that may be used as input to a kiosk in a shopping mall, etc. to cause it to dispense an appropriate physical voucher.

After the buyer receives the voucher, the buyer may present it to the issuing vendor for redemption. The vendor redeems the voucher in whole or in part, by permitting the buyer to use the card similarly to a gift card having a cash value in the amount of the stated value. Any unused amount may remain “on” the card for future use in substitution for cash, as generally known in the art for gift cards. The vendor's system may track the voucher balance, as generally known in the art for gift cards. In certain embodiments, a single card may be “refilled” by purchasing additional vouchers, the stated value of which are added to any previous balance.

Optionally, the system may track each bidder's purchases of vouchers, and present each bidder with a display via of the website of total savings resulted from discounted purchases of vouchers (e.g. $45 savings from purchases of $450 worth of stated value vouchers for a combined total of $405). In certain embodiments, the system may track bids and provide notices or awards in selected categories, e.g., highest bidder, most bids, most winning bids, etc. Optionally, the operator of the system may sell sponsorships for such awards, created an opportunity for advertising revenue streams.

FIG. 7 is a block diagram of a Marketplace Server 200 (see FIG. 1) in accordance with the present invention. The Marketplace Server 200 includes conventional server hardware storing and executing specially-configured computer software for carrying out a method in accordance with the present invention. Accordingly, the Marketplace Server 200 of FIG. 7 includes a general purpose microprocessor (CPU) 202 and a bus 204 employed to connect and enable communication between the microprocessor 202 and the components of the Marketplace Server 18 in accordance with known techniques. The Marketplace Server 18 typically includes a user interface adapter 206, which connects the microprocessor 202 via the bus 204 to one or more interface devices, such as a keyboard 208, mouse 210, and/or other interface devices 212, which can be any user interface device, such as a touch sensitive screen, digitized entry pad, etc. The bus 204 also connects a display device 214, such as an LCD screen or monitor, to the microprocessor 202 via a display adapter 216. The bus 204 also connects the microprocessor 202 to memory 218, which can include a hard drive, diskette drive, tape drive, etc.

The Marketplace Server 200 may communicate with other computers or networks of computers, for example via a communications channel, network card or modem 222. The Marketplace Server 200 may be associated with such other computers in a local area network (LAN) or a wide area network (WAN), and operates as a server in a client/server arrangement with another computer, etc. Such configurations, as well as the appropriate communications hardware and software, are known in the art.

The Marketplace Server's software is specially configured in accordance with the present invention. Accordingly, as shown in FIG. 7, the Marketplace Server 200 includes computer-readable, microprocessor-executable instructions stored in the memory for carrying out the methods described herein. Further, the memory stores certain data, e.g. in databases shown logically in FIG. 7 for illustrative purposes, without regard to any particular embodiment in one or more hardware or software components.

Additionally, computer readable media storing computer readable code for carrying out the method steps identified above is provided. The computer readable media stores code for carrying out subprocesses for carrying out the methods described above.

A computer program product recorded on a computer readable medium for carrying out the method steps identified above is provided. The computer program product comprises computer readable means for carrying out the methods described above.

While there have been described herein the principles of the invention, it is to be understood by those skilled in the art that this description is made only by way of example and not as a limitation to the scope of the invention.

What is claimed is:

1. A computer-implemented method for managing a vendor's inventory of items for sale, said method being computer-implemented by a marketplace server computer having a microprocessor and a memory for storing instructions executable by the microprocessor, the method comprising:
receiving at the marketplace server computer the vendor's commitment to sell stated value vouchers having a stated cash value, each stated value voucher being redeemable by the vendor in the amount of the stated cash value for purchase of items from the vendor's inventory;
operating the marketplace server computer to maintain a website for displaying at a bidder's computing device a for-sale listing identifying a stated value voucher available for sale but omitting information identifying any pending bids, and for accepting the bidder's bid for at least one stated value voucher;
referencing at the marketplace server computer a predetermined rule for accepting a bid for sale of a stated value voucher;
approving at the marketplace server computer sale of a respective stated value voucher to a corresponding bidder for each bid acceptable according to the rule; and
tendering the respective stated value voucher to each corresponding bidder for each approved sale.

2. The method of claim 1, wherein the predetermined rule is established by the marketplace server and is applied to all for-sale listings of all bidders.

3. The method of claim 1, wherein the predetermined rule is specified by the each vendor for that vendor's stated value vouchers.

4. The method of claim 3, wherein the marketplace server computer displays to the vendor a menu of options, each option corresponding to a respective user-selectable rule.

5. The method of claim 1, wherein the for-sale listing displays a minimum bid for the stated value voucher.

6. The method of claim 1, wherein tendering the respective stated value voucher to each corresponding bidder comprises the marketplace server computer electronically transmitting the stated value voucher to each bidder.

7. The method of claim 1, wherein tendering the respective stated value voucher to each corresponding bidder comprises the marketplace server computer transmitting data approving physical delivery of a tangible stated value voucher to each bidder.

8. The method of claim 1, wherein tendering the respective stated value voucher to each corresponding bidder comprises the marketplace server computer transmitting data to a kiosk to authorize the kiosk to dispense a stated value voucher to each bidder.

9. The method of claim 1, further comprising the marketplace server computer processing a bidder's payment for the stated value voucher.

10. The method of claim 1, further comprising the marketplace server computer transmitting to a vendor's computing device transaction information for sales of respective stated value vouchers to each respective bidder for each approved sale, the transaction information identifying the bidder, the respective stated value voucher to be purchased by the bidder, the bidder's bid, and payment processing information for the bidder.

11. The method of claim 1, further comprising the marketplace server computer aggregating a buyer's discounts from prior purchases of discounted stated value vouchers, and transmitting data to the buyer's computer device to display the aggregated discount.

12. A computer-implemented method for managing a vendor's inventory of items for sale, said method being computer-implemented by a marketplace server computer having a microprocessor and a memory for storing instructions executable by the microprocessor, the method comprising:
receiving at the marketplace server computer the vendor's commitment to sell stated value vouchers having a stated cash value, each stated value voucher being redeemable by the vendor in the amount of the stated cash value for purchase of items from the vendor's inventory;
receiving at the marketplace server computer the vendor's identification of a minimum bid acceptable to the vendor for sale of a stated value voucher, the vendor providing varying instructions from time to time;
transmitting from the marketplace server computer data for causing display at a bidder's computing device of a for-sale listing identifying a specified number of the stated value vouchers available for sale;
receiving at the marketplace server computer a plurality of bids for the stated value vouchers from a plurality of bidders' computing devices;
comparing at the marketplace server computer each of the plurality of bids to the vendor's current time-variant minimum acceptable bid;
approving at the marketplace server computer sale of a stated value voucher to the corresponding bidder for each bid exceeding a current minimum acceptable bid, a collective number of approved sales exceeding the specified number of stated value vouchers for sale; and
tendering a respective stated value voucher to each respective bidder for each approved sale.

13. The method of claim 12, wherein the for-sale listing omits information identifying any pending bids, and for accepting the bidder's bid for at least one of the stated value voucher.

14. The method of claim 12, wherein receiving the vendor's identification of a minimum bid acceptable to the vendor for sale of a stated value voucher comprises receiving multiple different minimum bids from the vendor during the pendency of the for-sale listing, and wherein comparing each of the plurality of bids to the vendor's current time-variant minimum acceptable bid comprises comparing the multiple different minimum bids to bids received during the pendency of the for-sale listing, whereby the vendor manages the inventory of sale items by varying the minimum acceptable bid and thus the discounts available for purchase of items from the inventory.

15. The method of claim 12, wherein the predetermined rule is specified by the each vendor for that vendor's stated value vouchers, the marketplace server computer displays to the vendor a menu of options, each option corresponding to a respective user-selectable rule.

16. The method of claim 12, wherein tendering the respective stated value voucher to each corresponding bidder comprises the marketplace server computer electronically transmitting the stated value voucher to each bidder.

17. The method of claim 12, wherein tendering the respective stated value voucher to each corresponding bidder comprises the marketplace server computer transmitting an authorization to a kiosk to cause the kiosk to dispense a stated value voucher to each bidder.

18. The method of claim 12, further comprising the marketplace server computer:
retrieving from the memory at the marketplace server contact information for the vendor; and
transmitting to the vendor's computing device, using the contact information, transaction information for sales of respective stated value vouchers to each respective bidder for each approved sale, the transaction information identifying the bidder, the respective stated value voucher to be purchased by the bidder, the bidder's bid, and payment processing information for the bidder to permit the vendor to process the bidder's payment for the stated value voucher.

19. The method of claim 12, further comprising the marketplace server computer aggregating a buyer's discounts from prior purchases of discounted stated value vouchers, and transmitting data to the buyer's computer device to display the aggregated discount.

20. A computer program product comprising instructions recorded on a computer-readable medium, the instructions being executable by a microprocessor of a marketplace server computer to cause the marketplace server computer to:
receive a vendor's commitment to sell stated value vouchers having a stated cash value;
receive, from time to time, the vendor's identification of a minimum bid acceptable to the vendor for sale of a stated value voucher;
transmit data for causing display at a bidder's computing device of a for-sale listing identifying a specified number of the stated value vouchers available for sale;
receive a plurality of bids for the stated value vouchers from a plurality of bidders' computing devices;
compare each of the plurality of bids to the vendor's current time-variant minimum acceptable bid;
approve sale of a stated value voucher to the corresponding bidder for each bid exceeding a current minimum acceptable bid; and
authorize tendering of a respective stated value voucher to each respective bidder for each approved sale.

21. A marketplace server computer system for managing a vendor's inventory of items for sale, the system comprising:
a microprocessor;
a memory for storing instructions executable by the microprocessor, the memory being operatively connected to the microprocessor and storing microprocessor-executable instructions for causing the microprocessor to carry out the method of claim 1.

22. A marketplace server computer system for managing a vendor's inventory of items for sale, the system comprising:
a microprocessor;
a memory for storing instructions executable by the microprocessor, the memory being operatively connected to the microprocessor and storing microprocessor-executable instructions for causing the microprocessor to carry out the method of claim 12.

23. A computer-implemented method for managing a vendor's inventory of items for sale, said method being computer-implemented by a marketplace server computer having a microprocessor and a memory for storing instructions executable by the microprocessor, the method comprising the microprocessor executing the instructions to cause the marketplace server computer to:
display at a buyer's computing device a for-sale listing identifying a lot of stated value vouchers available for purchase, each stated value voucher having a stated cash value, each stated value voucher being redeemable by the vendor in the amount of the stated cash value for purchase of an item from the vendor, but being available for purchase at less than the stated cash value;
reference a predetermined rule applicable to sale of the lot of stated value vouchers;
approve sale of the stated value vouchers to a plurality of buyers according to the rule; and
tender a respective stated value voucher to each of the plurality of buyers.

24. The method of claim 23, wherein the rule provides parameters for sale of the lot of vouchers.

25. The method of claim 23, wherein the rule reflects the vendor's instructions for sale of the stated value vouchers.

26. The method of claim 25, wherein the instructions comprise an agreement to sell the voucher in accordance with pre-determined guidelines.

27. The method of claim 26, wherein the guidelines are selected by the vendor from a set of alternative options.

28. The method of claim 24, wherein the rule establishes a number of stated value vouchers that may be sold.

29. The method of claim 23, wherein the rule establishes a number of stated value vouchers to be sold.

30. The method of claim 23, wherein the for-sale listing identifies a specific number of stated value vouchers available for purchase, and wherein the rule provides for sale of a number of stated value vouchers greater than the specific number.

31. The method of claim 23, wherein the stated value vouchers are sold in a purchase/sale transaction.

32. The method of claim 23, wherein the stated value vouchers are sold in an auction transaction.

33. A computer-implemented method for managing a vendor's inventory of items for sale, said method being computer-implemented by a marketplace server computer having a microprocessor and a memory for storing instructions executable by the microprocessor, the method comprising:
transmitting from the marketplace server computer data for causing display at a computing device of a for-sale listing identifying a specified number of stated value vouchers available for purchase, each of the stated value vouchers having a stated cash value, each stated value voucher being redeemable by the vendor in the amount of the stated cash value for purchase of an item from the vendor;
receiving at the marketplace server computer a plurality of buyers' indications to purchase the stated value vouchers from a plurality of buyer's computing devices;
comparing at the marketplace server computer the plurality of indications to the vendor's instructions for approval of sale of the specified number of stated value vouchers;
approving at the marketplace server computer sale of the specified number of stated value vouchers to the plurality of buyers consistent with the vendor's instructions for approval of sale of the specified number of stated value vouchers; and
tendering a respective stated value voucher to each of the plurality of buyers.

34. A computer-implemented method for processing payment transactions for purchases of stated value vouchers made by a plurality of buyers, said method being computer-implemented by a marketplace server computer having a microprocessor and a memory for storing instructions executable by the microprocessor, the method comprising:
transmitting from the marketplace server computer data for causing display at a computing device of a for-sale listing identifying a plurality of stated value vouchers available for purchase, each of the stated value vouchers having a stated cash value, each stated value voucher being redeemable by the vendor in the amount of the stated cash value for purchase of an item from the vendor;
approving sale of a stated value voucher to a buyer consistent with a predetermined rule for sale of the stated value vouchers;
receiving at the marketplace server computer the buyer's payment processing information for use to purchase the stated value voucher;
referencing information stored at the marketplace server computer to identify contact information for the vendor, the contact information identifying a payment processing computer system;
transmitting transaction information from the marketplace server computer to the payment processing computer system identified by the vendor's contact information, the transaction information comprising the buyer's payment processing information and sale transaction-related information; and
the payment processing computer system fulfilling sale of the stated value voucher to the buyer by processing a payment using the buyer's payment processing information and tendering the purchased stated value voucher to the buyer using the transaction-related information.

35. The method of claim 34, wherein the transaction-related information comprises at least one of a purchase quantity, a sale price, a stated value of the purchased voucher, a mailing address for the buyer, an e-mail address for the buyer, and a coupon code.

36. The method of claim 34, wherein transmitting transaction information from the marketplace server computer of the payment processing computer system identified by the vendor's contact information comprises:
transmitting data to a secure electronic repository of information.

37. The method of claim 36, wherein transmitting data to a secure electronic repository of information is performed using electronic data interchange (EDI) technology.

38. The method of claim 34, further comprising:
approving sale of a stated value voucher to each of a plurality of buyers, consistent with the predetermined rule;
receiving at the marketplace server computer respective payment processing information for use to purchase a stated value voucher by each of the plurality of buyers;
aggregating transaction information for the plurality of buyers for transactions involving a single vendor;
transmitting the aggregated transaction information to the single vendor.
